(19) United States
(12) Patent Application Publication
(10) Pub. No.: US 2021/0219407 A1
(43) Pub. Date: Jul. 15, 2021

(54) SYSTEM AND METHOD OF NEUTRALIZING ELECTOSTATIC ENERGY

(71) Applicant: Ronald Matthew PAYNE, Huntsville (CA)

(72) Inventor: Ronald Matthew PAYNE, Huntsville (CA)

(21) Appl. No.: 16/741,696

(22) Filed: Jan. 13, 2020

(51) Int. Cl. H05F 3/02

(52) U.S. Cl. CPC H05F 3/02

(57) ABSTRACT

An electrostatic dissipation device having a housing constructed with a protruding conductive element that fixes to a grounded feature of the environment, such as the ground return of a household electrical system. A second moveable conductive element is partially contained within the housing and can be mechanically moved to electrically connect with the first element. The second element is also connected to a spring that widens the contact area between the second element and the human operator by requiring some depressive force. Dissipation of static charge from the human operator occurs as the second conductive element becomes close enough to the arcing distance to the first conductive element. Pain is minimized for the human operator while dissipating static charge.

### BACKGROUND

The embodiments described herein relate to static dissipation devices particularly static dissipation devices intended to dissipate static charge that is built up on a human body.

A well-known problem in industry and more generally in modern people's everyday lives is the buildup of static electricity, particularly on human bodies. Static electricity is an imbalance of electric charges within or on the surface of a material. In particular, many modern materials, such as plastics and other synthetic materials create static charge by tribocharging and also function as an insulating element. Tribocharging is a contact electrification process that enables buildup of static electricity due to touching or rubbing of surfaces in specific combinations of two dissimilar materials. If an insulating element isolates the human body, the body can retain a static charge for a long time.

An aspect of the static charge is normally measured as an electrical potential in Volts, and in many cases, a human body in conjunction with static generating materials such as synthetic rugs and synthetic shoe soles can generate very high voltages, in the order of tens of thousands of volts. These voltages create problems when a human body comes in contact with a conductive object at a different potential, as the voltages are equalized rapidly in an electrical current known as ESD, or Electro Static Discharge. Particularly problematic are conductive objects that are connected to a ground or earth potential (0 Volts).

The rapid equalization of the electric potential between the electrical object often creates a small electrical arc in the air between the two objects, where the air becomes a conductor. A spark is triggered when the electric field strength exceeds approximately 4-30 kV/cm[2]—the dielectric field strength of air. This may cause a very rapid increase in the number of free electrons and ions in the air, temporarily causing the air to abruptly become an electrical conductor in a process called dielectric breakdown.

ESD can cause harmful effects of importance in home, industry and automotive environments, including explosions in gas, fuel vapor and coal dust, as well as failure of solid state electronics components such as integrated circuits. These can suffer permanent damage when subjected to high voltages. Electronics manufacturers therefore establish electrostatic protective areas free of static, using measures to prevent charging, such as avoiding highly chargeable materials and measures to remove static such as grounding human workers, providing antistatic devices, and controlling humidity.

In industry, particularly in industries that use microelectronics, sophisticated ESD prevention systems are instituted. This is required because many electronic circuits are highly sensitive and can become damaged or inoperable if subjected to ESD events. These sophisticated systems often include humidity control systems, special anti-static clothing, conductive coatings, human grounding straps, and ion generation devices. While such systems are appropriate in an industrial setting, they are complex and costly for environments such as a home or automotive environment.

A reason that ESD discharges are particularly unpleasant is that the electrical arc during a discharge is concentrated at a small area where the air abruptly becomes an electrical conductor in a process called dielectric breakdown. The cells and nerves in the human body in that small area must endure a concentration of electric current and energy for a short time. Notably, although charge is being equalized throughout the entire human body, the pain is felt specifically at the contact point or the location of the highest concentration of current. Providing a system to ensure that area of contact for the electrostatic discharge is not a small point, but is distributed over a larger area of the human body, will reduce the painfulness of the ESD event.

Some manufacturers produce ‘ESD discharge’ devices that purport to safely discharge static buildup. One example of such a product is ‘Uxcell Static Discharger’ which is a cylindrical device. The device uses a neon bulb to slow the discharge of an ESD event when one end is held by a charged human, and the second end is contacted to a grounded location. This product suffers from several disadvantages: a user has to remember to carry the device with them; the device is complex to manufacture; the user must properly ascertain which part of the object is conductive and the user must also ascertain which part of the object, if any, is properly grounded.

Apart from the above-mentioned problems associated with ESD events, ESD events experienced by humans can be frightening, unexpected and painful. What is needed is a simple, low cost, durable and effective device to neutralize static electricity in humans and to reduce the discomfort of static shock.

### SUMMARY

In one embodiment of the current invention, a housing is constructed with a protruding conductive element that fixes to a grounded feature of the environment, such as the ground return of a household electrical system. A second moveable conductive element is partially contained within the housing and can be mechanically moved to electrically connect with the first element. The second element is also connected to a spring that widens the contact area between the second element and the human operator by requiring some depressive force. Dissipation of static charge from the human operator occurs as the second conductive element becomes close enough to the arcing distance to the first conductive element. Pain is minimized for the human operator while dissipating static charge.

In some embodiments, the current invention can be placed at each human entryway to a facility, to permit personnel to safely dissipate their charges before entering the facility. Facilities that contain items that are sensitive to ESD, such as electronics manufacturing facilities would find this placement a particular advantage. Each person would be required to depress the button to discharge any static buildup on their person on entry. Additional placements of the device can be made of the invention to allow for convenient dissipation close to work areas, or in cases where static charges may be generated through work movements. Static can be generated inside a work environment and can be particularly problematic in the textile industry, or generated from worker's clothing. Changing rooms can also be a location where movement of fabric creates static charges.

Environments with low humidity, for example Huntsville, Ontario, Canada in the winter can be particularly problematic for the generation of static electricity. When the air has low humidity, the air becomes more electrically insulative, and electric charges remain on a human body for longer, and in many cases continue to build through movement. The dryness in these environments can be further increased by indoor heating systems such as wood or electric heat.

### BRIEF DESCRIPTION OF THE DRAWINGS

FIG. 1 illustrates a commercially available Antistatic Keychain Static Electricity Eliminator.

FIG. 2 shows an exploded view of one embodiment, along with an assembled view of the same embodiment.

FIG. 3 shows a mounting strategy for mounting one embodiment to a grounded switch box.

FIG. 4 shows a collection of end and top views of parts A and B of an embodiment of the current invention.

FIG. 5a shows a top view of a detail of an alternate embodiment for the ESD shock protection device.

FIG. 5b shows a front view of an alternate embodiment for the ESD shock protection device.

### DETAILED DESCRIPTION

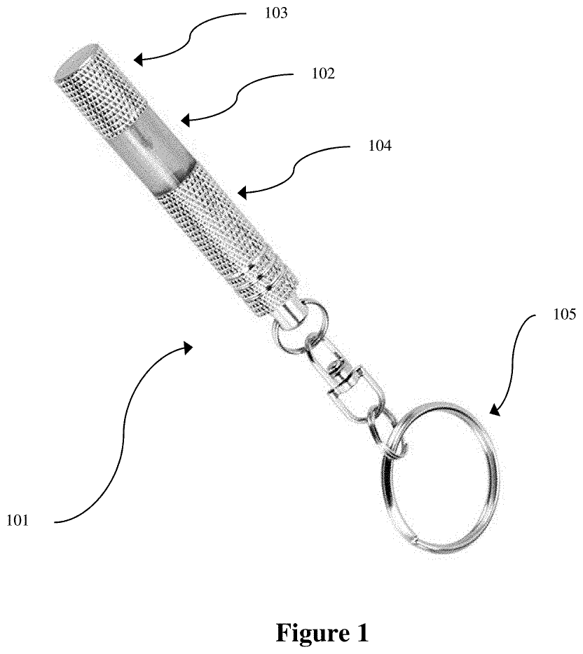

FIG. 1 illustrates a commercially available Antistatic Keychain Static Electricity Eliminator. Referring to FIG. 1, an existing ESD discharge solution 101 is shown, and is marketed as ‘Uxcell Static Discharger’. The device is intended to be used by a human to discharge electrostatic charge that they may have on their body to a grounded surface. The device is used by holding on to the device with a hand at location 104, and then touching the other end of the device 103 to a grounded surface. One well known and standardized electrical model of an electrically charged human is the Human Body Model or HBM. In both JS-001-2012 and MIL-STD-883H the charged human body is modeled by a 100 pF capacitor and a 1500 ohm discharging resistance. The electrostatic voltage of a charged human can be as high as several tens of thousands of volts. The voltage is equalized by passing the current from the charged human connected to 104 to the ground connection at 103 through a neon bulb element at 102. To facilitate carrying the device, a keychain is added to the device 105.

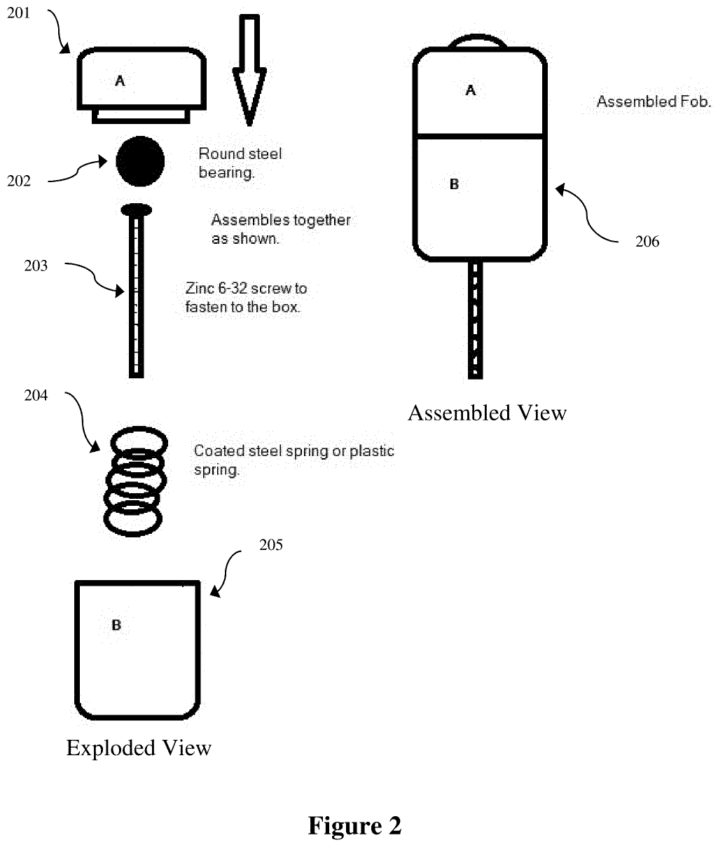

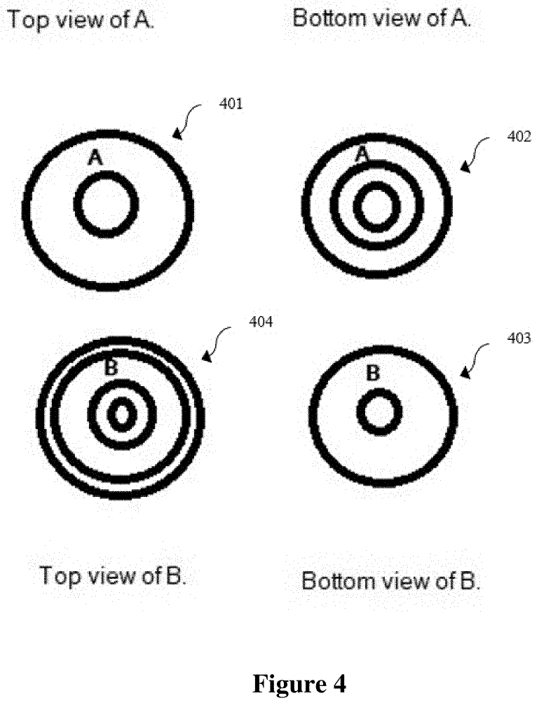

FIG. 2 shows an embodiment of the invention, in both exploded view and assembled view. The ESD discharge device has a top component A 201. In one embodiment, the Component A is circular in shape, and has an internal cavity that permits the internal components to be housed inside the assembled unit. This component is further detailed in FIG. 4. Component A may be of nearly any physical or decorative shape, and may also include logos, instructions or other markings to indicate how to use the product. Prototype parts were manufactured from Low Density Polyethylene (LDPE), due to the ease of machining and insulative properties. A wide variety of materials may be used for Component A, provided that the material is largely insulative.

Not shown in this drawing, but shown in FIG. 4, is a hole in the top surface of Component A. This hole is sized such that round steel bearing 202 protrudes slightly from the surface of Component A, but cannot pass through the hole in the top surface of Component A. Round steel bearing 202 was selected for the prototype because it is an excellent conductor, is relatively cheap, and has an excellent tactile feel. A wide variety of ornamental shapes could be used for part 202, provided that they can be contained within Component A, and are conductive to electricity. In addition, a variety of manufacturing techniques could be used for the round steel bearing 202, including plastic injection molding of a conductive material, electroplating over non-conductive materials, or manufacturing from one of many metals.

Immediately below the round steel bearing 202, is a spring 204. When assembled, the spring is compressed between the round steel bearing 202 and Component B, the bottom of the housing 205. The spring may be of any suitable spring material, including coated steel, plastic, or could be fabricated from a suitable rubber or foam. The spring provides pressure on the round steel bearing 202 to hold it firmly in place in Component A, and to provide a comfortable resistance when the round steel bearing 202 is pushed (or depressed) by a human finger. Another key consideration in selecting the spring material and force supplied by the spring (K constant), is to provide sufficient force back on the human finger to cause the finger to deform the finger slightly around the ball of the round steel bearing 202. This deformation increases the surface area of contact, and thus decreases the current per square unit area of contact. This reduction, in turn, decreases the pain to the human operator. The spring could be made of many materials, or alternatively the repulsive force could be implemented by using opposing fixed magnets.

As the operator first touches the round steel bearing 202 at first, the bearing is detached (isolated) from ground and will only have a minor charge equalization to the potential of the human body. As the round steel bearing 202 is pressed, the surface area of contact between the human operator's skin and the round steel bearing 202 increases, preferably to several square millimeters. As the round steel bearing 202 continues to be pressed, the bearing comes closer to the ground connected screw. As the round steel bearing travels further toward the screw, the potential of the now connected human and bearing will eventually form an electrical arc between the bearing and the screw. This occurs when the electric field strength exceeds approximately 4-30 kV/cm[2]—the dielectric field strength of air. Thus, the electrostatic discharge arc happens at some distance from the human operator, and the associated painful experience of a shock is not felt.

A particular advantage to minimizing the pain of ESD events is one of compliance. Personnel are reluctant to employ grounding or static charge elimination procedures if there is any chance of a painful shock. The current invention provides a mechanism to reduce the potential of a painful ESD event, and help to increase compliance.

As a secondary advantage to this embodiment, the arc contained inside a contained space and not in open air. With appropriate sealing to the enclosure, in particular adding a flexible sealed conductive membrane to the top of the bearing, any spark from an ESD discharge would be contained, and the potential for igniting a flammable or explosive material is greatly reduced. This advantage could find utility in environments such as refineries, mines, laboratories, chemical processing plants, or other spark sensitive (Intrinsically safe) environments.

The Zinc 6-32 screw 203 passes through the center of the spring and protrudes through a hole in the bottom of Component B. The hole in Component B is shown in greater detail in FIG. 4. The size and type of screw should be chosen to be appropriate to affix to a threaded hole in a feature of the environment that is electrically grounded. In one embodiment, a standard common grounded electrical switch box has a convenient threaded hole to mate with a 6-32 screw. The screw can be manufactured of a wide variety of different materials, provided that the screw is conductive.

As seen in the Assembled Fob 206 of FIG. 2, the gap between the top of the screw and the round steel bearing 202 are set to a distance. This distance is set by features in Component B (not shown) that contact the head of screw 203 and prevent the screw from protruding further from the assembly. The distance between the top of the head of the screw and the Round steel bearing should be set to be larger than an anticipated spark gap (when the electric field strength exceeds approximately 4-30 kV/cm[2]) and small enough so that when the round steel bearing 202 is pressed by a human finger, the travel of the bearing from top resting position to a position where the bearing is contacting the screw is not excessive, and is comfortable for the human operator.

Component A and Component B can be fixed to each other by one of several means. After Component B is mounted to a surface by the screw, Component A and Component B can be joined by a threaded connection, an interlocking bayonet type connection, an adhesive, interference fit, or one of many additional existing mechanical coupling mechanisms. Component A and Component B themselves can be manufactured from a wide variety of insulative materials, for various ornamental, durability, and cost requirements. One popular manufacturing technique would be to fabricate Component A and Component B from thermoplastic using a plastic injection mold process.

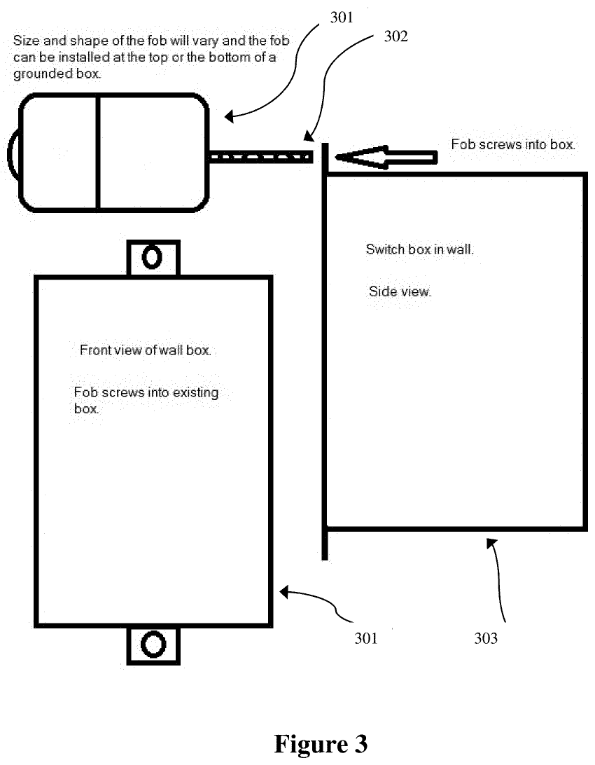

FIG. 3 shows one embodiment of an installation solution. The assembled device 301 screws into the standardized tapped hole at the top of Switch box 303. A front view of the switch box is shown as 304. An example of a common steel switch box would be the Steel City® metallic outlet boxes manufactured by Thomas and Betts. The screw 302 threads into the threaded hole in the Switch box 303. Several mechanisms could be used to connect the screw with the Switch box, including press connectors, conductive paint, screws, electrical tabs, conductive tape, and others. The requirement for the fixing solution is that there is an electrical connection to ground or similar, and that the assembled device be mechanically fixed to a surface. Other embodiments may relax the mechanical fixing requirement, provided that at least a resistive path to ground or similar potential is made available. For example, the assembled device could be fixed to a grounded cable or cord to allow an operator to frequently discharge static electricity, yet still retain mobility.

FIG. 4 shows additional views of Component A and Component B. The top view of Component A is shown in 401. The center hole in 401 is where the operator depresses the exposed bearing. The bottom view of Component A is shown in 402 and shows the same through hole as in 401, and additionally reveals an inner cavity where the bearing is housed. The bottom view of Component B is shown in 403. This through hole is the pass-through hole for the screw. The top view of Component B is shown in 404. The innermost through hole for the screw is in the center of the view. The second innermost ring is the edge of the shelf that establishes the screw height relative to the bearing. The next innermost feature is the cavity that contains the spring, then the outermost wall at the edge of the view.

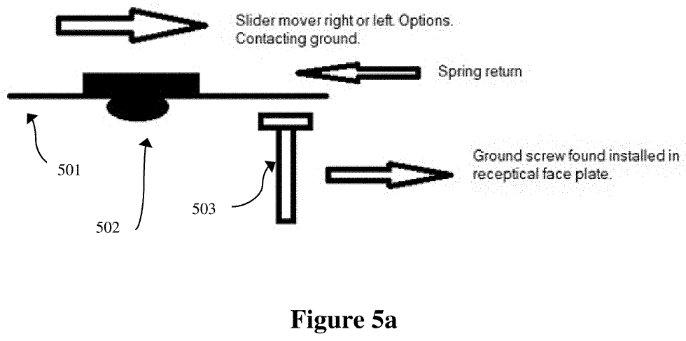

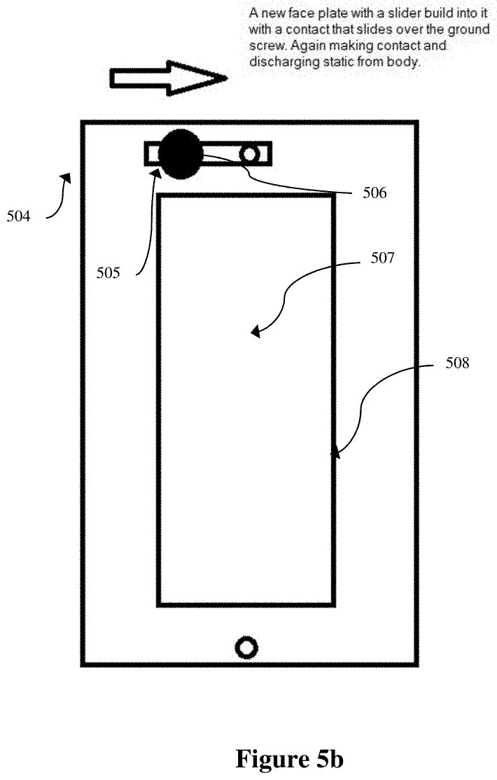

FIG. 5a shows an alternate embodiment of the ESD protection device. Conductive element 502 is set in a channel in plane 501 and free to slide from side to side. At the extreme travel of the conductive element, electrical contact with the ground screw 503 is made. This assembly functions to expand the surface area of contact between the human operator's skin and the contact element, in this case the top surface of conductive element 502. In addition, any arc that occurs when the charges are being equalized is kept away from the human body, in this case between the conductive element and the ground screw. In one embodiment, the ground screw is electrically connected to the electrical box, which in turn is connected by electrical wiring to earth ground. Not shown is a return spring element that applies a force to the conductive element to return the conductive element to a position that is not touching the ground screw. In one embodiment, the return spring element is non-conductive, so that the discharge of a static charge can be controlled by the mechanical movement of the conductive element.

FIG. 5b shows a front view of a light switch 508 incorporating this embodiment. The conductive element 504 is permitted to move along the channel 506 towards the ground screw 505. The human body static charge is dissipated when the conductive element contacts the ground screw. Power switch 507 is not impacted by the ESD dissipation components, and can function as a switch independent of the ESD dissipation elements added to the switch.

While the described embodiment of the invention satisfies the requirements put forth in the goals, alternate embodiments may also find further advantage to incorporate resistive components in the discharge path. This has the additional advantage of spreading the electrostatic discharge over a greater time period, thus reducing the peak energy, and experience of pain. Other components that have similar energy absorbing characteristics are transient voltage suppressors, Zener diodes, and neon lamps. A suitable location to insert an absorbing component such as a resistor, would be to provide a resistive flexible covering over the exposed side of the bearing.

In addition, another embodiment could be used to neutralize the relative charge between two charged bodies, as opposed to neutralizing the charge of one body to ground. This could be accomplished by creating a ‘dual’ device where the screws are connected and each human operator would have a bearing on opposite ends of a device to push.

Another embodiment could be provided with a visual indicator such as a LED or neon indicator that flashes when a discharge is in progress. A capacitor and potentially an additional delay circuit could be used to lengthen the duration of the visual indication so that the it can be observed by the human operator.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters and configurations described herein are meant to be exemplary inventive features and that other equivalents to the specific inventive implementations described herein may be realized. It is, therefore, to be understood that the foregoing implementations are presented by way of example and that, within the scope of the appended claims and equivalents thereto, inventive implementations may be practiced otherwise than as specifically described and claimed. Inventive implementations of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

All definitions, as defined and used herein, should be understood to control over dictionary definitions, definitions in documents incorporated by reference, and/or ordinary meanings of the defined terms.

What is claimed:

1. An electrostatic dissipation device, the device comprising:
a housing;
a first conductive element capable of operably mounting to a grounded feature of the environment;
a second moveable conductive element configured to be mechanically moved by a human operator to electrically connect with the first conductive element; and
a spring mechanically connected to the second conductive element to resist the movement of the second conductive element towards the first conductive element.

2. The device of claim 1, where the device is configured to be attached to any one of a metal junction box, a grounded machine, a conductive cable, an architectural feature of a building that is grounded, water piping, a surface with conductive paint, or a resistive path to ground.

3. The device of claim 1, where the device expands the contact area between the second conductor and the human operator whilst being activated.

4. The device of claim 1, where the electro static discharge arc occurs between the first and second conductive elements.

5. The device of claim 1, where the device has a visual indication that an electrostatic discharge has occurred.

6. The device of claim 1, where the device incorporates an energy absorptive element to further reduce the peak intensity of the electrostatic discharge event.

7. The device of claim 1, where the device is configured to have a plurality of second conductors to equalize the static charges between at least two bodies.

8. A method of reducing electrostatic discharge, the method comprising:
fixing a first conductor to an at least partially conductive material capable of transferring charge to an area of differing static electrical potential;
providing a mechanical path for a second conductor to move towards the first conductor;
providing a means to mechanically resist the movement of the second conductor towards the first conductor; and
providing a mechanical interface for a user to overcome the mechanical resistance and cause the second conductor to contact the first conductor.

9. The method of claim 8, where the first conductor is configured to be electrically attached to any one of a metal junction box, a grounded machine, an architectural feature of a building that is grounded, water piping, a surface with conductive paint, or a resistive path to ground.

10. The method of claim 8, where moving the second conductor expands the contact area between the second conductor and the human operator whilst being activated.

11. The method of claim 8, where the electro static discharge arc occurs between the first and second conductors.

12. The method of claim 8, where a visual indication is given indicating that an electrostatic discharge has occurred.

13. The method of claim 8, whereby an energy absorptive element further reduces the peak intensity of the electrostatic discharge event.

14. The method of claim 8, where a plurality of second conductors are configured to equalize the static charges between at least two bodies.

15. A method of containing the spark from an electro-static discharge, the method comprising:
providing a mechanical enclosure that blocks the passage of volatile or explosive gasses;
fixing a first conductor to an at least partially conductive material capable of transferring charge to an area of differing static electrical potential;
providing a mechanical path for a second conductor to move towards the first conductor;
providing a means to mechanically resist the movement of the second conductor towards the first conductor; and
providing a mechanical interface for a user to overcome the mechanical resistance and cause the second conductor to contact the first conductor;
whereby both the first conductor and the second conductor are within the mechanical enclosure.

16. The method of claim 15, where the first conductor is configured to be electrically attached to any one of a metal junction box, a grounded machine, an architectural feature of a building that is grounded, water piping, a surface with conductive paint, or a resistive path to ground.

17. The device of claim 15, where the electro static discharge arc occurs between the first and second conductors.

18. The method of claim 15, where a visual indication is given indicating that an electrostatic discharge has occurred.

19. The method of claim 15, whereby an energy absorptive element further reduces the peak intensity of the electrostatic discharge event.

20. The method of claim 15, where a plurality of second conductors are configured to equalize the static charges between at least two bodies.
